(19) United States
(12) Patent Application Publication
(10) Pub. No.: US 2026/0023275 A1
(43) Pub. Date: Jan. 22, 2026

(54) PHASE DIFFERENCE MODULATION DEVICE

(71) Applicant: Japan Display Inc., Tokyo (JP)

(72) Inventors: Toshiharu MATSUSHIMA, Tokyo (JP); Shunichi KIMURA, Tokyo (JP)

(21) Appl. No.: 19/270,826

(22) Filed: Jul. 16, 2025

(30) Foreign Application Priority Data
Jul. 18, 2024 (JP) 2024-114604

(51) Int. Cl. G02F 1/133; G02F 1/1343

(52) U.S. Cl. CPC G02F 1/13306; G02F 1/134309

(57) ABSTRACT

According to an aspect, a phase difference modulation device includes a first substrate provided with a first electrode and a second electrode adjacent to each other, a second substrate provided with a third electrode overlapping the first and second electrodes, a liquid crystal layer between the first and second substrates, and a control circuit. When switching from a state in which the potential of the first electrode is a first potential and the potential of the second electrode is a second potential higher than the first potential to a state in which the potential of the second electrode is the first potential and the potential of the first electrode is a predetermined potential, the control circuit switches the potential of the first electrode from the first potential to a third potential higher than the predetermined potential and then to the predetermined potential.

### CROSS-REFERENCE TO RELATED APPLICATION

This application claims the benefit of priority from Japanese Patent Application No. 2024-114604 filed on Jul. 18, 2024, the entire contents of which are incorporated herein by reference.

### BACKGROUND

### 1. Technical Field

What is disclosed herein relates to a phase difference modulation device.

### 2. Description of the Related Art

WO 2016/117604 discloses a liquid crystal element configured to refract and emit light, as an example of a phase difference modulation device. In the phase difference modulation device of WO 2016/117604, when voltage is applied to a first electrode and a second electrode and the potentials of the first and second electrodes are different from each other, a potential gradient is generated in a high-resistance layer, causing liquid crystal molecules to tilt. In this case, light is refracted due to the tilt of the liquid crystal molecules. In contrast to this, when no voltage is applied to the first and second electrodes and the potentials of the first and second electrodes are equal to each other, no potential gradient is generated in the high-resistance layer, and the liquid crystal molecules do not tilt. In this case, light is not refracted.

In the phase difference modulation device of WO 2016/117604, the liquid crystal molecules change from a tilted state to a non-tilted state in a transition from a state in which voltage is applied to the first and second electrodes and light is refracted to a state in which no voltage is applied to the first and second electrodes and light is not refracted. In this case, since the liquid crystal molecules operate due to the elasticity of the liquid crystal layer, the operation speed of the liquid crystal molecules is slower than in a case where voltage is applied to the first and second electrodes and the tilt state of the liquid crystal molecules changes. Accordingly, a time required for the refractive state to change from a state in which light is refracted is relatively long.

For the foregoing reasons, there is a need for a phase difference modulation device capable of shortening a time required for the refractive state to change from a state in which light is refracted.

### SUMMARY

According to an aspect, a phase difference modulation device of the present disclosure includes a first substrate provided with a first electrode and a second electrode that are disposed adjacent to each other in a plan view, a second substrate provided with a third electrode overlapping the first and second electrodes in a plan view, a liquid crystal layer disposed between the first and second substrates, and a control circuit configured to apply voltage to the first, second, and third electrodes to impart a phase difference to an electromagnetic wave passing through the liquid crystal layer. When switching from a state in which the potential of the first electrode is a first potential and the potential of the second electrode is a second potential higher than the first potential to a state in which the potential of the second electrode is the first potential and the potential of the first electrode is a predetermined potential, the control circuit switches the potential of the first electrode from the first potential to a third potential higher than the predetermined potential and then to the predetermined potential.

### BRIEF DESCRIPTION OF THE DRAWINGS

FIG. 1 is a conceptual diagram of a phase difference modulation device according to an embodiment of the present disclosure;

FIG. 2 is a plan view of a phase difference modulation element according to the embodiment of the present disclosure;

FIG. 3 is a sectional view of the phase difference modulation element along line III-III illustrated in FIG. 2;

FIG. 4 is a diagram illustrating the relation between the potential of each of first and second electrodes and the amount of change in the phase of emission light passing through a liquid crystal layer;

FIG. 5 is a diagram illustrating the potential of each electric resistance film and the phase difference of emission light passing through the liquid crystal layer when the phase difference modulation element refracts emission light in a fourth direction;

FIG. 6 is a diagram illustrating the potential of the electric resistance film and the phase difference of emission light passing through the liquid crystal layer when the phase difference modulation element refracts emission light in a fifth direction;

FIG. 7 is a time chart of the potentials of each first electrode and each second electrode in a first switching operation in a comparative example;

FIG. 8 is a time chart of the amounts of phase change of emission light at each first liquid crystal portion and each second liquid crystal portion in the first switching operation in the comparative example;

FIG. 9 is a time chart of the phase difference between emission light at each first liquid crystal portion and emission light at each second liquid crystal portion in the first switching operation in the comparative example;

FIG. 10 is a time chart of the potentials of each first electrode and each second electrode in the first switching operation in the embodiment of the present disclosure;

FIG. 11 is a time chart of the amounts of phase change of emission light at each first liquid crystal portion and each second liquid crystal portion in the first switching operation in the embodiment of the present disclosure;

FIG. 12 is a time chart of the phase difference between emission light at each first liquid crystal portion and emission light at each second liquid crystal portion in the first switching operation in the embodiment of the present disclosure;

FIG. 13 is a time chart of the potentials of each first electrode and each second electrode in second switching operation in the comparative example;

FIG. 14 is a time chart of the amounts of phase change of emission light at each first liquid crystal portion and each second liquid crystal portion in the first switching operation in the comparative example;

FIG. 15 is a time chart of the phase difference between emission light at each first liquid crystal portion and emission light at each second liquid crystal portion in the second switching operation in the comparative example;

FIG. 16 is a time chart of the potentials of each first electrode and each second electrode in the second switching operation in the embodiment of the present disclosure;

FIG. 17 is a time chart of the amounts of phase change of emission light at each first liquid crystal portion and each second liquid crystal portion in the second switching operation in the embodiment of the present disclosure;

FIG. 18 is a time chart of the phase difference between emission light at each first liquid crystal portion and emission light at each second liquid crystal portion in the second switching operation in the embodiment of the present disclosure;

FIG. 19 is a plan view of a phase difference modulation element included in a phase difference modulation device according to a modification of the embodiment of the present disclosure; and

FIG. 20 is a sectional view of the phase difference modulation element along line XX-XX illustrated in FIG. 19.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference signs are applied to the same elements as those already described for the previously mentioned drawings, and detailed explanations may be omitted as appropriate.

A first direction D1 and a second direction D2 in the drawings correspond to directions parallel to the plate surfaces of substrates included in a phase difference modulation element 2 to be described later. The first direction D1 and the second direction D2 correspond to directions along sides of the phase difference modulation element 2. In the first direction D1, a side indicated by an arrow is a positive D1 side, and a side opposite to the positive D1 side is a negative D1 side. In the second direction D2, a side indicated by an arrow is a positive D2 side, and a side opposite to the positive D2 side is a negative D2 side.

A third direction D3 corresponds to the thickness direction of the phase difference modulation element 2. In the third direction D3, a side indicated by an arrow is a positive D3 side, and a side opposite to the positive D3 side is a negative D3 side. The positive D3 side in the third direction D3 corresponds to the front surface side of the phase difference modulation element 2, and the negative D3 side in the third direction D3 corresponds to the back surface side of the phase difference modulation element 2. In the present specification, a “plan view” is a view of the phase difference modulation element 2 in the third direction D3. The first direction D1, the second direction D2, and the third direction D3 are exemplary, and the present disclosure is not limited to these directions.

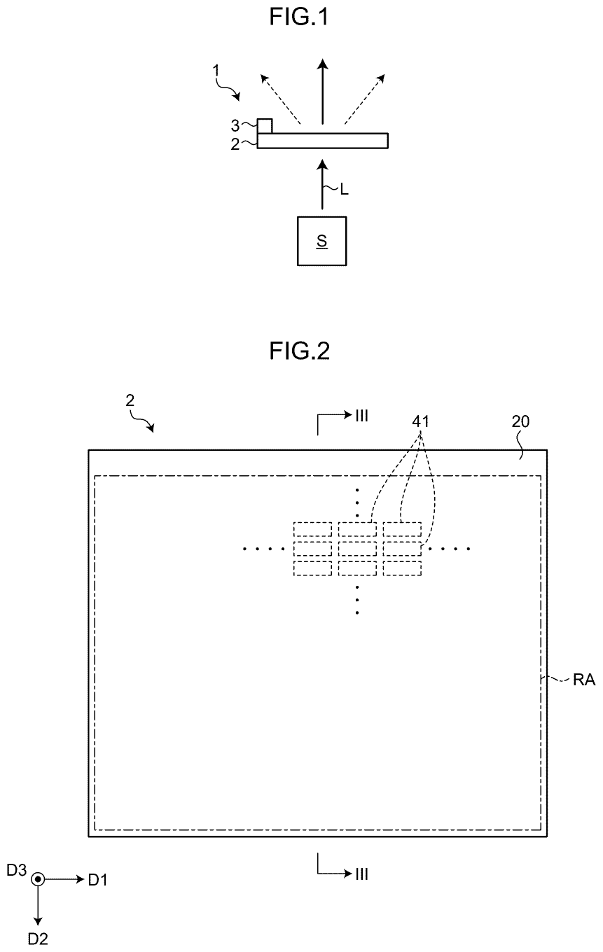

FIG. 1 is a conceptual diagram of a phase difference modulation device 1 according to an embodiment of the present disclosure. The phase difference modulation device 1 includes the phase difference modulation element 2 and a control circuit 3.

The phase difference modulation element 2 is a refractive plate that refracts an electromagnetic wave. The electromagnetic wave includes visible light and electric waves. The following describes a case where the phase difference modulation element 2 refracts emission light L that is visible light emitted from a light source S. The light source S is, for example, an illumination device such as a vehicle headlight or a spotlight. The emission light L is incident on the phase difference modulation element 2.

The phase difference modulation element 2 has a state allowing the emission light L to be transmitted therethrough without changing a direction (emission direction) in which the emission light L travels, as illustrated with a solid arrow, and a state allowing the emission light L to be transmitted therethrough while refracting the emission light L in one of two directions illustrated with dashed arrows (details will be described later).

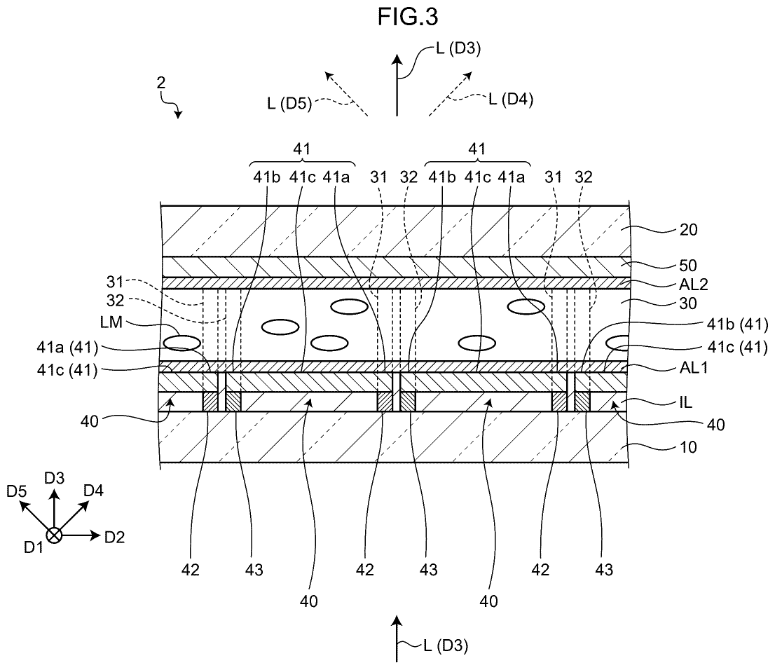

FIG. 2 is a plan view of the phase difference modulation element 2 according to the embodiment of the present disclosure. FIG. 3 is a sectional view of the phase difference modulation element 2 along line III-III illustrated in FIG. 2. The sectional view of the phase difference modulation element 2 illustrated in FIG. 3 illustrates a sectional shape of the phase difference modulation element 2 along a plane orthogonal to the first direction D1.

The phase difference modulation element 2 includes a first substrate 10, a second substrate 20, and a liquid crystal layer 30. The first substrate 10 and the second substrate 20 overlap each other in a plan view. The first substrate 10 and the second substrate 20 have a light-transmitting property. The first substrate 10 and the second substrate 20 are, for example, glass substrates, resin substrates, or resin films.

A plurality of element sets 40, an insulating layer IL, and a first alignment film AL1 are disposed on the first substrate 10. Each element set 40 includes an electric resistance film 41, a first electrode 42, and a second electrode 43.

As illustrated in FIG. 2, the electric resistance films 41 are arranged in a matrix of rows and columns in the first direction D1 and the second direction D2 in a plan view. In a plan view, the electric resistance films 41 each have a rectangular shape with the length of the first direction D1 being longer than the length of the second direction D2. In a plan view, the electric resistance films 41 overlap a refraction region RA that refracts the emission light L.

The electric resistance values of the electric resistance films 41 are larger than the electric resistance values of the first electrodes 42 and the second electrodes 43. The material of the electric resistance films 41 is a conductive material having a light-transmitting property such as zinc oxide (ZnO) or indium gallium zinc oxide (IGZO).

Each electric resistance film 41 is electrically coupled to the corresponding first and second electrodes 42 and 43 on the negative D3 side.

In a plan view, the first electrode 42 extends in the first direction D1 and overlaps the electric resistance film 41 on a first end (the positive D2 side) of the electric resistance film 41 in the second direction D2. The first electrode 42 is in contact with the electric resistance film 41.

In a plan view, the second electrode 43 extends along the first direction D1 and overlaps the electric resistance film 41 on a second end (the negative D2 side) of the electric resistance film 41 in the second direction D2. The second electrode 43 is in contact with the electric resistance film 41.

The first and second electrodes 42 and 43 overlap the electric resistance film 41 in a state of facing each other in the second direction D2 in a plan view. In other words, the first and second electrodes 42 and 43 are disposed at positions adjacent to each other in a plan view.

In the electric resistance film 41, a portion overlapping the first electrode 42 in a plan view is referred to as a first overlapping portion 41a, a portion overlapping the second electrode 43 in a plan view is referred to as a second overlapping portion 41b, and a portion between the first and second overlapping portions 41a and 41b is referred to as a middle portion 41c. In the second direction D2, the length of the middle portion 41c is longer than the sum of the length of the first overlapping portion 41a and the length of the second overlapping portion 41b.

The element sets 40 are disposed in the insulating layer IL. The first alignment film AL1 is disposed on the positive D3 side of the element sets 40 and the insulating layer IL.

A third electrode 50 and a second alignment film AL2 are disposed on the second substrate 20.

The third electrode 50 overlaps the electric resistance films 41 in a plan view. The third electrode 50 also overlaps the first and second electrodes 42 and 43 in a plan view.

The material of the first electrodes 42, the second electrodes 43, and the third electrode 50 is a conductive material having a light-transmitting property such as indium tin oxide (ITO), indium zinc oxide (IZO), indium gallium oxide (IGO), or indium gallium zinc oxide (IGZO).

The second alignment film AL2 is disposed on the negative D3 side of the third electrode 50.

The liquid crystal layer 30 is disposed between the first substrate 10 and the second substrate 20. The liquid crystal layer 30 is sandwiched between the first alignment film AL1 and the second alignment film AL2. The first alignment film AL1 and the second alignment film AL2 induces a predetermined alignment (initial alignment) of liquid crystal molecules LM contained in the liquid crystal layer 30 when no voltage is applied to the phase difference modulation element 2. The initial alignment of the liquid crystal molecules LM is such a direction (horizontal alignment) that the long axis of each liquid crystal molecule LM is orthogonal to the third direction D3. The alignment direction of the first alignment film AL1 and the alignment direction of the second alignment film AL2 are orthogonal to each other in a plan view.

The phase difference modulation element 2 is a twisted nematic (TN) liquid crystal element. However, the phase difference modulation element 2 is not limited to a twisted nematic liquid crystal element.

The control circuit 3 controls the phase difference modulation element 2. Specifically, the control circuit 3 applies voltage (alternating-current voltage) to the first, second, and third electrodes 42, 43, and 50 and imparts a phase difference to an electromagnetic wave (the emission light L) passing through the liquid crystal layer 30. Accordingly, the emission light L is refracted by the phase difference modulation element 2. In the present embodiment, the control circuit 3 applies a reference potential (0 V) to the third electrode 50. The potential of the third electrode 50 is not limited to the reference potential (0 V). The following describes a case where the alignment direction of the first alignment film AL1 is along the second direction D2 and the emission light L is linearly polarized light having a polarization direction along the second direction D2.

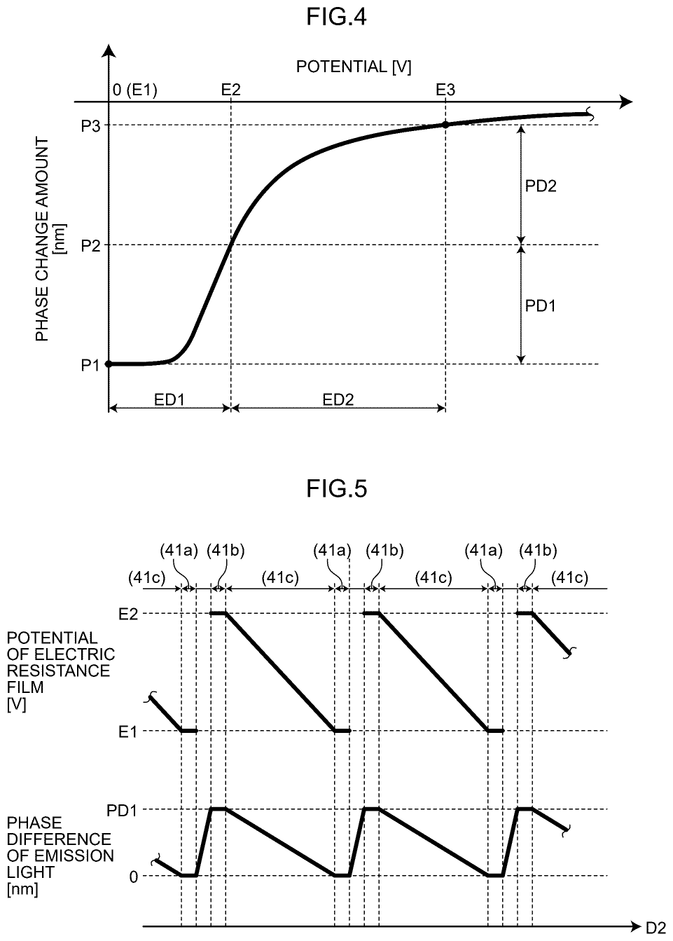

FIG. 4 is a diagram illustrating the relation between the potential of each of the first electrode 42 and the second electrode 43 and the amount of change in the phase of the emission light L passing through the liquid crystal layer 30. Each potential illustrated in FIG. 4 is equivalent to the effective value of an alternating-current voltage (the same applies to FIGS. 5, 6, 7, 10, 13, and 16 to be described later). Each potential illustrated in FIG. 4 may be the maximum value or average value of the alternating-current voltage. Specifically, FIG. 4 illustrates the relation between the potential of each of the first electrode 42 and the second electrode 43 and the amount of change in the phase (hereinafter referred to as the amount of phase change) of the emission light L passing through the liquid crystal layer 30 when the potentials of the first and second electrodes 42 and 43 change relative to the potential of the third electrode 50 in a state in which the potentials of the first and second electrodes 42 and 43 are equal to each other. Accordingly, the potential illustrated in FIG. 4 is equivalent to a potential difference relative to the potential of the third electrode 50 (the same applies to FIGS. 5, 6, 7, 10, 13, and 16 to be described later). In the present embodiment, the potential of the third electrode 50 is the reference potential (0 V).

In FIG. 4, when the degree of tilt of the long axis of each liquid crystal molecule LM relative to the initial alignment (horizontal alignment) of the liquid crystal molecule LM is maximum (that is, when the long axis of the liquid crystal molecule LM is parallel to the third direction D3), the amount of phase change of the emission light L passing through the liquid crystal layer 30 is 0 (nm) and the phase of the emission light L passing through the liquid crystal layer 30 does not change. As the long axis of the liquid crystal molecule LM tilts relative to the state of being parallel to the third direction D3 and approaches the state of the initial alignment (horizontal alignment) of the liquid crystal molecule LM, the amount of phase change decreases from 0 (zero) and the phase of the emission light L is delayed.

In the present embodiment, when the potentials of the first and second electrodes 42 and 43 are equal to the reference potential (0 (V)), the liquid crystal molecules LM are in the initial alignment (horizontal alignment) and the amount of phase change of the emission light L passing through the liquid crystal layer 30 is minimum (first phase P1). In other words, when the potentials of the first and second electrodes 42 and 43 are 0 (zero), the phase of the emission light L passing through the liquid crystal layer 30 is most delayed. When no potential is applied to the phase difference modulation element 2, the potentials of the first, second, and third electrodes 42, 43, and 50 are 0 (zero) and the amount of phase change of the emission light L passing through the liquid crystal layer 30 is minimum.

As the potentials of the first and second electrodes 42 and 43 increase, the degree of tilt of the liquid crystal molecules LM increases from the state of the initial alignment (horizontal alignment) and the amount of phase change of the emission light L passing through the liquid crystal layer 30 increases (in other words, phase delay decreases). The relation between the potential of each of the first and second electrodes 42 and 43 and the amount of phase change of the emission light L passing through the liquid crystal layer 30 in FIG. 4 is exemplary, and the present disclosure is not limited to the relation illustrated in FIG. 4.

When no voltage is applied to the phase difference modulation element 2 or when the potentials of the first and second electrodes 42 and 43 are equal to each other, the amount of phase change of the emission light L passing through the liquid crystal layer 30 is equal at all portions of the liquid crystal layer 30, and no phase difference occurs in the emission light L. Accordingly, the phase difference modulation element 2 causes the emission light L to exit therefrom without refraction. Specifically, as illustrated in FIG. 3, the phase difference modulation element 2 causes the emission light L incident in the third direction D3 to exit in the third direction D3 without refraction. A reference sign inside parentheses of the emission light L indicates the direction in which the emission light L travels. In FIG. 3, the emission light L from the phase difference modulation element 2 is illustrated on the positive D3 side of the phase difference modulation element 2.

When voltage is applied to the phase difference modulation element 2 so that the potentials of the first and second electrodes 42 and 43 are different from each other, a phase difference occurs in the emission light L passing through the liquid crystal layer 30 as described later since the degrees of tilt of the liquid crystal molecules LM in the liquid crystal layer 30 are different from each other. In this case, the phase difference modulation element 2 refracts and transmits the emission light L.

The following describes operation when the phase difference modulation element 2 refracts the emission light L from the light source S. The emission light L enters the phase difference modulation element 2 in the third direction D3 from the back surface of the first substrate 10. The phase difference modulation element 2 refracts and transmits the emission light L in a fourth direction D4 or a fifth direction D5. In the present embodiment, the angle between the third direction D3 and the fourth direction D4 is equal to that between the third direction D3 and the fifth direction D5.

FIG. 5 is a diagram illustrating the potential of each electric resistance film 41 and the phase difference of the emission light L passing through the liquid crystal layer 30 when the phase difference modulation element 2 refracts the emission light L in the fourth direction D4. The fourth direction D4 is a direction tilted on the positive D2 side relative to the third direction D3 as illustrated in FIG. 3.

The horizontal axis illustrated in FIG. 5 represents the position (coordinate) in an X direction. A reference sign inside parentheses is the reference sign of a portion of an electric resistance film 41 illustrated in FIG. 3, and an arrow corresponding to the reference sign indicates the region of the portion of the electric resistance film 41 corresponding to the reference sign.

When the phase difference modulation element 2 refracts the emission light L in the fourth direction D4, a first potential E1 is applied to the first electrodes 42 and a second potential E2 higher than the first potential E1 is applied to the second electrodes 43 by the control circuit 3. In the present embodiment, the first potential E1 is equal to the potential of the third electrode 50. In other words, in the present embodiment, the first potential E1 is the reference potential (0 (V)) of the control circuit 3 (in other words, the first potential E1=0 (V) in the present embodiment).

In this case, in one electric resistance film 41, the potential of the second overlapping portion 41b in contact with the second electrode 43 is equal to the second potential E2. In one electric resistance film 41, the potential of the middle portion 41c between the first and second electrodes 42 and 43 changes linearly from the second potential E2 to the first potential E1 from the negative D2 side toward the positive D2 side in the second direction D2. In one electric resistance film 41, the potential of the first overlapping portion 41a in contact with the first electrode 42 is equal to the first potential E1.

The first potential E1 (reference potential (0 V)) is applied to the third electrode 50 by the control circuit 3. The potential difference between the first potential E1 and the second potential E2 depends on the angle between the third direction D3 and the fourth direction D4. In other words, the degree of tilt of the fourth direction D4 relative to the third direction D3 can be adjusted by the potential difference between the first potential E1 and the second potential E2.

An electric field generated by potential application to the first, second, and third electrodes 42, 43, and 50 acts on the liquid crystal layer 30 and tilts the liquid crystal molecules LM, and the amount of phase change illustrated in FIG. 4 is imparted to the emission light L. Accordingly, the refractive index of the emission light L in the liquid crystal layer 30 changes in the second direction D2, resulting in a phase difference of the emission light L passing through the liquid crystal layer 30.

Specifically, the amount of phase change of the emission light L at a first liquid crystal portion 31 between each first electrode 42 and the third electrode 50 in the liquid crystal layer 30 illustrated in FIG. 3 is the first phase P1 when the potential of the first electrode 42 is the first potential E1 (in the present embodiment, 0 (V)) as illustrated in FIG. 4. The amount of phase change of the emission light L at a second liquid crystal portion 32 between each second electrode 43 and the third electrode 50 in the liquid crystal layer 30 illustrated in FIG. 3 is a second phase P2, which is larger than the first phase P1, when the potential of the second electrode 43 is the second potential E2 larger than the first potential E1 as illustrated in FIG. 4. Therefore, the magnitude of the phase difference between the emission light L passing through the first liquid crystal portion 31 and the emission light L passing through the second liquid crystal portion 32 is equivalent to a first phase difference PD1 that is the magnitude of the difference between the first phase P1 and the second phase P2. The first phase difference PD1 is equivalent to the magnitude of the phase difference of the emission light L, which corresponds to a first potential difference ED1 between the first potential E1 and the second potential E2.

A solid line representing the phase difference of the emission light L passing through the liquid crystal layer 30 in FIG. 5 indicates a locus with the same phase as a reference phase (that is, the phase difference is 0 (nm)) that is the phase at a position corresponding to an end of each first liquid crystal portion 31 on the most negative D2 side in the second direction D2.

The phase difference of the emission light L passing through the liquid crystal layer 30 changes in a zigzag pattern in the second direction D2 between 0 (zero) and the first phase difference PD1. Specifically, the phase difference of the emission light L at the second liquid crystal portions 32 corresponding to the second overlapping portions 41b is the first phase difference PD1. The phase difference of the emission light L at portions of the liquid crystal layer 30 corresponding to the middle portions 41c changes linearly from the first phase difference PD1 to 0 (zero) from the negative D2 side toward the positive D2 side in the second direction D2. The phase difference of the emission light L at the first liquid crystal portions 31 corresponding to the first overlapping portions 41a is 0 (zero).

The phase difference of the emission light L between two electric resistance films 41 adjacent to each other in the second direction D2 changes linearly from 0 (zero) to the first phase difference PD1 from the negative D2 side toward the positive D2 side in the second direction D2.

The degree of the gradient of the phase difference of the emission light L at portions of the liquid crystal layer 30 corresponding to the middle portions 41c corresponds to the angle between the third direction D3 and the fourth direction D4. In the second direction D2, the length of each portion of the liquid crystal layer 30 corresponding to a middle portion 41c is longer than the sum of the lengths of portions of the liquid crystal layer 30 corresponding to the first and second overlapping portions 41a and 41b.

As the phase difference of the emission light L passing through the liquid crystal layer 30 changes as illustrated in FIG. 5, the emission light L is refracted by the liquid crystal layer 30 and exits in the fourth direction D4 from the phase difference modulation element 2.

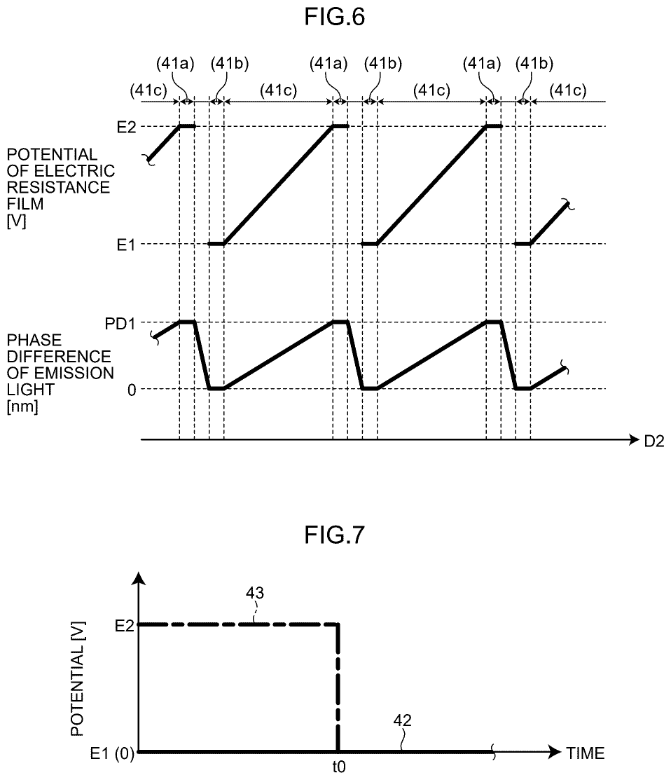

FIG. 6 is a diagram illustrating the potential of each electric resistance film 41 and the phase difference of the emission light L passing through the liquid crystal layer 30 when the phase difference modulation element 2 refracts the emission light L in the fifth direction D5. The fifth direction D5 is a direction tilted on the negative D2 side relative to the third direction D3 as illustrated in FIG. 3.

When the phase difference modulation element 2 refracts the emission light L in the fifth direction D5, the second potential E2 is applied to the first electrodes 42 and the first potential E1 is applied to the second electrodes 43 by the control circuit 3.

In this case, as illustrated in FIG. 6, in one electric resistance film 41, the potential of the second overlapping portion 41b in contact with the second electrode 43 is equal to the first potential E1. In one electric resistance film 41, the potential of the middle portion 41c changes linearly from the first potential E1 to the second potential E2 from the negative D2 side toward the positive D2 side in the second direction D2. In one electric resistance film 41, the potential of the first overlapping portion 41a in contact with the first electrode 42 is equal to the second potential E2.

The first potential E1 is applied to the third electrode 50 by the control circuit 3. The potential difference between the first potential E1 and the second potential E2 depends on the angle between the third direction D3 and the fifth direction D5. Thus, the degree of tilt of the fifth direction D5 relative to the third direction D3 can be adjusted by the potential difference between the first potential E1 and the second potential E2.

An electric field generated by potential application to the first, second, and third electrodes 42, 43, and 50 acts on the liquid crystal layer 30 and tilts the liquid crystal molecules LM, and the amount of phase change illustrated in FIG. 4 is imparted to the emission light L. Accordingly, the refractive index of the emission light L in the liquid crystal layer 30 changes in the second direction D2, resulting in a phase difference of the emission light L passing through the liquid crystal layer 30.

Specifically, since the potential of the first electrode 42 is the second potential E2 and the potential of the second electrode 43 is the first potential E1, the magnitude of the difference between the phase of the emission light L passing through the first liquid crystal portion 31 and the phase of the emission light L passing through the second liquid crystal portion 32 corresponds to the first phase difference PD1 as the magnitude of the difference between the first phase P1 and the second phase P2.

A solid line representing the phase difference of the emission light L passing through the liquid crystal layer 30 in FIG. 6 indicates a locus with the same phase as a reference phase (that is, the phase difference is 0 (zero)) at a position corresponding to an end of each second liquid crystal portion 32 on the most positive D2 side in the second direction D2.

The phase difference of the emission light L passing through the liquid crystal layer 30 changes in a zigzag pattern in the second direction D2 between 0 (zero) and the first phase difference PD1. Specifically, the phase difference of the emission light L at the second liquid crystal portions 32 corresponding to the second overlapping portions 41b is 0 (zero). The phase difference of the emission light L at portions of the liquid crystal layer 30 corresponding to the middle portions 41c changes linearly from 0 (zero) to the first phase difference PD1 from the negative D2 side toward the positive D2 side in the second direction D2. The phase difference of the emission light L at the first liquid crystal portions 31 corresponding to the first overlapping portions 41a is the first phase difference PD1.

The phase difference of the emission light L between two electric resistance films 41 adjacent to each other in the second direction D2 changes linearly from the first phase difference PD1 to 0 (zero) from the negative D2 side toward the positive D2 side in the second direction D2.

The degree of the gradient of the phase difference of the emission light L at portions of the liquid crystal layer 30 corresponding to the middle portions 41c corresponds to the angle between the third direction D3 and the fifth direction D5.

As the phase difference of the emission light L passing through the liquid crystal layer 30 changes as illustrated in FIG. 6, the emission light L is refracted by the liquid crystal layer 30 and exits in the fifth direction D5 from the phase difference modulation element 2.

The following describes a first switching operation of the phase difference modulation element 2, in which the phase difference modulation element 2 switches from a state of causing the emission light L to exit therefrom in the fourth direction D4 to a state of causing the emission light L to exit therefrom in the third direction D3. In the first switching operation, the control circuit 3 switches from a state in which the potential of each first electrode 42 is the first potential E1 and the potential of each second electrode 43 is the second potential E2 higher than the first potential E1 to a state in which the potential of each second electrode 43 and the potential of each first electrode 42 are the first potential E1 (equivalent to “predetermined potential” in the first switching operation).

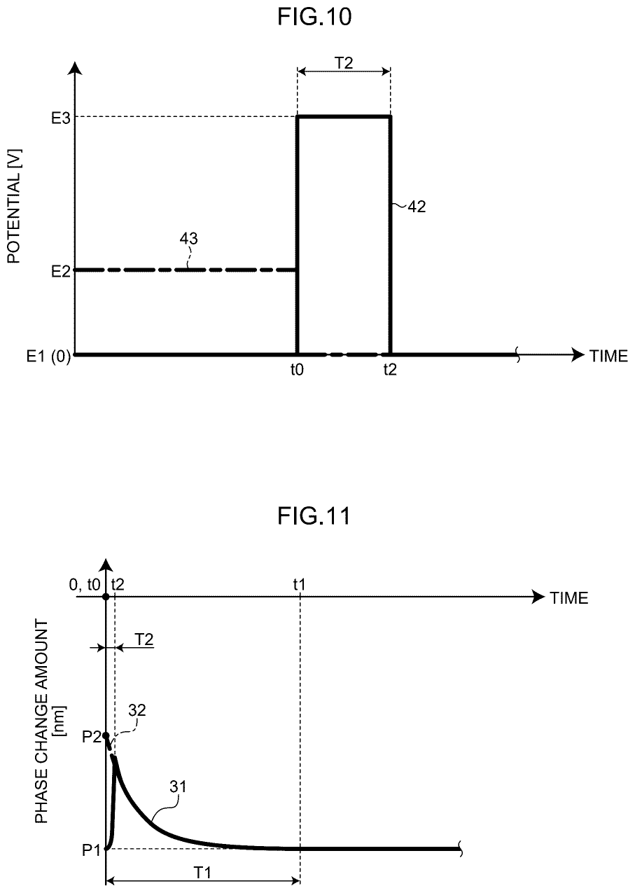

FIG. 7 is a time chart of the potentials of each first electrode 42 and each second electrode 43 in the first switching operation in a comparative example. In FIG. 7 and FIGS. 10, 13, and 16 to be described later, the potential of the first electrode 42 is indicated with a solid line, the potential of the second electrode 43 is indicated with a dashed and single-dotted line, and parts of the potential of the second electrode 43, which overlap the potential of the first electrode 42, are indicated with a solid line.

In the first switching operation in the comparative example, at a switching timing, the control circuit 3 directly switches from a state in which the potential of each first electrode 42 is the first potential E1 and the potential of each second electrode 43 is the second potential E2 higher than the first potential E1 to a state in which the potential of each second electrode 43 and the potential of each first electrode 42 are the first potential E1.

Specifically, before a switching time point to (switching timing) illustrated in FIG. 7, the potential of each first electrode 42 is the first potential E1 (reference potential; 0 (V)), the potential of each second electrode 43 is the second potential E2, and the phase difference modulation element 2 causes the emission light L to exit therefrom in the fourth direction D4 as described above.

In the first switching operation in the comparative example, the control circuit 3 sets the potential of each second electrode 43 to the first potential E1 at the switching time point to. The control circuit 3 maintains the potential of each first electrode 42 at the first potential E1 without change at the switching time point to.

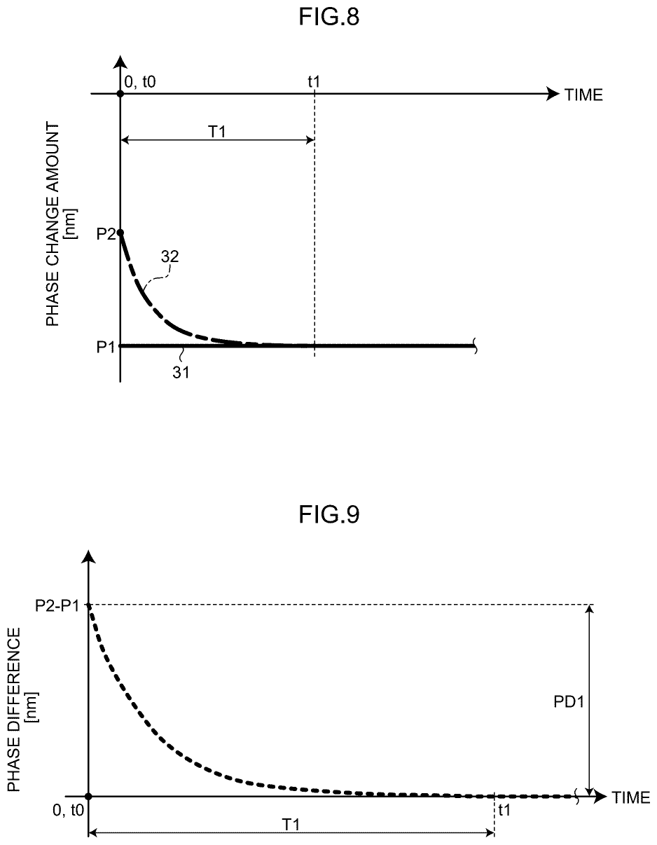

FIG. 8 is a time chart of the amounts of phase change of the emission light L at each first liquid crystal portion 31 and each second liquid crystal portion 32 in the first switching operation in the comparative example. In FIG. 8 and FIGS. 11, 14, and 17 to be described later, the amount of phase change of the emission light L at the first liquid crystal portion 31 is indicated with a solid line, the amount of phase change of the emission light L at the second liquid crystal portion 32 is indicated with a dashed and single-dotted line, and parts of the amount of phase change of the emission light L at the second liquid crystal portion 32, which overlap the amount of phase change of the emission light L at the first liquid crystal portion 31, are indicated with a solid line.

When the potential of each second electrode 43 is switched from the second potential E2 to the first potential E1 at the switching time point to (FIG. 7), the degree of tilt of the liquid crystal molecules LM at the second liquid crystal portion 32 corresponding to the second electrode 43 decreases toward the state of the initial alignment corresponding to the first potential E1 due to the elasticity of the liquid crystal layer 30. Accordingly, as illustrated in FIG. 8, the amount of phase change of the emission light L at the second liquid crystal portion 32 decreases from the second phase P2 corresponding to the second potential E2 at the switching time point to and becomes the first phase P1 corresponding to the first potential E1 at a first time point t1 after elapse of a first time T1 since the switching time point to. The first time T1 depends on the viscosity of the liquid crystal layer 30 and the like.

As illustrated in FIG. 7, the potential of each first electrode 42 remains at the first potential E1 even after the switching time point to. Accordingly, as illustrated in FIG. 8, the phase of the emission light L at each first liquid crystal portion 31 remains at the first phase P1.

FIG. 9 is a time chart of the phase difference between the emission light L at each first liquid crystal portion 31 and the emission light L at each second liquid crystal portion 32 in the first switching operation in the comparative example.

FIG. 9 illustrates the difference between the amount of phase change of the emission light L at each first liquid crystal portion 31 and the amount of phase change of the emission light L at each second liquid crystal portion 32, which are illustrated in FIG. 8. As illustrated in FIG. 9, the phase difference of the emission light L becomes a value obtained by subtracting the first phase P1 from the second phase P2 at the switching time point to. The magnitude of the phase difference of the emission light L decreases from the first phase difference PD1 at the switching time point to and becomes 0 (zero) at the first time point t1.

Accordingly, the phase difference modulation element 2 causes the emission light L to exit therefrom in the fourth direction D4 before the switching time point to and causes the emission light L to exit therefrom in the third direction D3 at the first time point t1 or later. From the switching time point t0 to the first time point t1, the direction of the emission light L changes from the fourth direction D4 to the third direction D3 over the first time T1.

In this manner, in the first switching operation in the comparative example, a switching time in which the direction of the emission light L switches from the fourth direction D4 to the third direction D3 is equivalent to the first time T1. However, there is a demand to shorten the switching time. Thus, the control circuit 3 controls voltage applied to the first and second electrodes 42 and 43 as described below.

FIG. 10 is a time chart of the potentials of each first electrode 42 and each second electrode 43 in the first switching operation according to the embodiment of the present disclosure.

Before the switching time point to illustrated in FIG. 10, the potential of each first electrode 42 is the first potential E1 (reference potential; 0 (V)), the potential of each second electrode 43 is the second potential E2, and the phase difference modulation element 2 causes the emission light L to exit therefrom in the fourth direction D4 as described above.

In the first switching operation of the present embodiment, the control circuit 3 switches the potential of each second electrode 43 to the first potential E1 at the switching time point to, as in the first switching operation in the comparative example described above. The control circuit 3 switches the potential of each first electrode 42 from the first potential E1 to a third potential E3, which is higher than the first potential E1, at the switching time point to, and then to the first potential E1.

In the first switching operation of the present embodiment, the third potential E3 is set as follows. As illustrated in FIG. 4, the third potential E3 is higher than the second potential E2. A third phase P3 that is the amount of phase change of the emission light L, which corresponds to the third potential E3, is larger than the second phase P2. A second phase difference PD2 that is the magnitude of the difference between the second phase P2 and the third phase P3 is equal to or larger than the first phase difference PD1. In other words, the second phase difference PD2 as the magnitude of the phase difference of the emission light L, which corresponds to a second potential difference ED2 between the second potential E2 and the third potential E3, is equal to or larger than the first phase difference PD1 as the magnitude of the phase difference of the emission light L, which corresponds to the first potential difference ED1 between the first potential E1 and the second potential E2. The third potential E3 may be set so that the second phase difference PD2 is smaller than the first phase difference PD1. The third potential E3 may be higher than the first potential E1 and equal to or lower than the second potential E2.

As illustrated in FIG. 10, the control circuit 3 sets the potential of each first electrode 42 to the third potential E3 at the switching time point to. Then, the control circuit 3 switches the potential of each first electrode 42 from the third potential E3 to the first potential E1 at a second time point t2 after elapse of a second time T2 since the switching time point to. The second time T2 is set to a time that is shorter than the first time T1 and is set such that the degree of tilt of the liquid crystal molecules LM at each first liquid crystal portion 31 is substantially equal to the degree of tilt of the liquid crystal molecules LM at each second liquid crystal portion 32 at the second time point t2.

FIG. 11 is a time chart of the amounts of phase change of the emission light L at each first liquid crystal portion 31 and each second liquid crystal portion 32 in the first switching operation according to the embodiment of the present disclosure.

As in the first switching operation in the comparative example described above, when the potential of each second electrode 43 is switched from the second potential E2 to the first potential E1 at the switching time point to (refer to FIG. 10), the amount of phase change of the emission light L at the second liquid crystal portion 32 corresponding to the second electrode 43 decreases from the second phase P2 at the switching time point to and becomes the first phase P1 at the first time point t1 as illustrated in FIG. 11.

When the potential of each first electrode 42 is switched from the first potential E1 to the third potential E3 at the switching time point to (refer to FIG. 10), the degree of tilt of the liquid crystal molecules LM at the first liquid crystal portion 31 corresponding to the first electrode 42 increases from the state of the initial alignment corresponding to the first potential E1. Then, the degree of tilt of the liquid crystal molecules LM at the first liquid crystal portion 31 becomes substantially equal to the degree of tilt of the liquid crystal molecules LM at the second liquid crystal portion 32 at the second time point t2. Accordingly, as illustrated in FIG. 11, the amount of phase change of the emission light L at the first liquid crystal portion 31 increases from the first phase P1 corresponding to the first potential E1 at the switching time point to and becomes substantially equal to the amount of phase change of the emission light L at the second liquid crystal portion 32 at the second time point t2.

Moreover, when the potential of each first electrode 42 is switched from the third potential E3 to the first potential E1 at the second time point t2 (refer to FIG. 10), the degree of tilt of the liquid crystal molecules LM at each first liquid crystal portion 31 decreases toward the state of the initial alignment due to the elasticity of the liquid crystal layer 30. Accordingly, as illustrated in FIG. 11, the amount of phase change of the emission light L at each first liquid crystal portion 31 decreases from the second time point t2 and becomes the first phase P1.

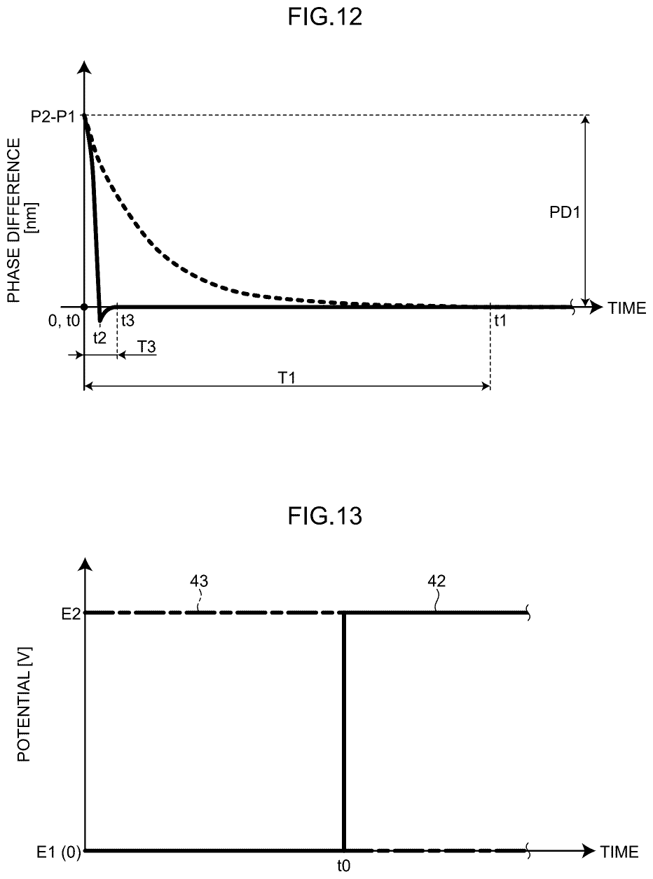

FIG. 12 is a time chart of the phase difference between the emission light L at each first liquid crystal portion 31 and the emission light L at each second liquid crystal portion 32 in the first switching operation according to the embodiment of the present disclosure. In FIG. 12, the phase difference of the emission light L related to the first switching operation according to the embodiment of the present disclosure is indicated with a solid line, and the phase difference of the emission light L related to the first switching operation in the comparative example illustrated in FIG. 9 is indicated with a dashed line.

FIG. 12 illustrates the phase difference between the amount of phase change of the emission light L at each first liquid crystal portion 31 and the amount of phase change of the emission light L at each second liquid crystal portion 32, which are illustrated in FIG. 11. As illustrated in FIG. 12, the phase difference of the emission light L is a value obtained by subtracting the first phase P1 from the second phase P2 at the switching time point to. The magnitude of the phase difference of the emission light L decreases from the first phase difference PD1 at the switching time point to and becomes 0 (zero) at a third time point t3 between the second time point t2 and the first time point t1.

Accordingly, the phase difference modulation element 2 causes the emission light L to exit therefrom in the fourth direction D4 before the switching time point to and causes the emission light L to exit therefrom in the third direction D3 at the third time point t3 or later. From the switching time point t0 to the third time point t3, the direction of the emission light L changes from the fourth direction D4 to the third direction D3 over a third time T3.

Between the third time point t3 and the first time point t1 in FIG. 12, the degree of tilt of the liquid crystal molecules LM changes at each of the first and second liquid crystal portions 31 and 32 while maintaining a state in which the magnitude of the phase difference of the emission light L is 0 (zero). Accordingly, the emission light L is caused to exit in the third direction D3 at the third time point t3 or later.

In this manner, the switching time of the first switching operation of the present embodiment in which the phase difference modulation element 2 switches from a state of causing the emission light L to exit therefrom in the fourth direction D4 to a state of causing the emission light L to exit therefrom in the third direction D3, is equivalent to the third time T3 from the switching time point t0 to the third time point t3. The third time T3 is shorter than the first time T1 equivalent to the switching time of the first switching operation in the comparative example. In this manner, the phase difference modulation device 1 can shorten a time required for the refractive state to change from a state in which the emission light L is refracted.

The following describes a second switching operation of the phase difference modulation element 2, in which the phase difference modulation element 2 switches from a state of causing the emission light L to exit therefrom in the fourth direction D4 to a state of causing the emission light L to exit therefrom in the fifth direction D5. In the second switching operation, the control circuit 3 switches from a state in which the potential of each first electrode 42 is the first potential E1 and the potential of each second electrode 43 is the second potential E2 higher than the first potential E1 to a state in which the potential of each second electrode 43 is the first potential E1 and the potential of each first electrode 42 is the second potential E2 (equivalent to “predetermined potential” in the second switching operation).

FIG. 13 is a time chart of the potentials of each first electrode 42 and each second electrode 43 in the second switching operation in the comparative example.

In the second switching operation in the comparative example, at a switching timing, the control circuit 3 directly switches from a state in which the potential of each first electrode 42 is the first potential E1 and the potential of each second electrode 43 is the second potential E2 higher than the first potential E1 to a state in which the potential of each second electrode 43 is the first potential E1 and the potential of each first electrode 42 is the second potential E2.

Before the switching time point to illustrated in FIG. 13, the potential of each first electrode 42 is the first potential E1 (reference potential; 0 (V)), the potential of each second electrode 43 is the second potential E2, and the phase difference modulation element 2 causes the emission light L to exit therefrom in the fourth direction D4 as described above.

In the second switching operation in the comparative example, the control circuit 3 sets the potential of each second electrode 43 to the first potential E1 at the switching time point to. The control circuit 3 sets the potential of each first electrode 42 to the second potential E2 at the switching time point to.

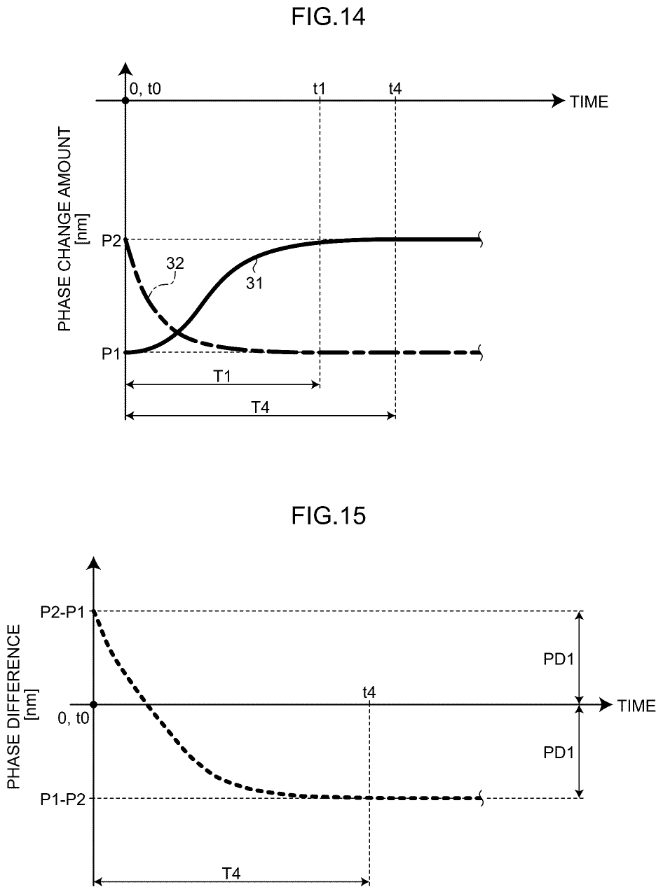

FIG. 14 is a time chart of the amounts of phase change of the emission light L at each first liquid crystal portion 31 and each second liquid crystal portion 32 in the first switching operation in the comparative example.

When the potential of each second electrode 43 is switched from the second potential E2 to the first potential E1 at the switching time point to (FIG. 13), the degree of tilt of the liquid crystal molecules LM at the second liquid crystal portion 32 corresponding to the second electrode 43 decreases toward the state of the initial alignment due to the elasticity of the liquid crystal layer 30. Accordingly, as illustrated in FIG. 14, the amount of phase change of the emission light L at each second liquid crystal portion 32 decreases from the second phase P2 at the switching time point to and becomes the first phase P1 at the first time point t1 after elapse of the first time T1 since the switching time point to.

When the potential of each first electrode 42 is switched from the first potential E1 to the second potential E2 at the switching time point to (FIG. 13), the degree of tilt of the liquid crystal molecules LM at the first liquid crystal portion 31 corresponding to the first electrode 42 increases from the state of the initial alignment. Accordingly, as illustrated in FIG. 14, the amount of phase change of the emission light L at each first liquid crystal portion 31 increases from the first phase P1 at the switching time point to and becomes the second phase P2 at a fourth time point t4 after elapse of a fourth time T4 since the switching time point to. In the present embodiment, the fourth time T4 is longer than the first time T1.

FIG. 15 is a time chart of the phase difference between the emission light L at each first liquid crystal portion 31 and the emission light L at each second liquid crystal portion 32 in the second switching operation in the comparative example.

FIG. 15 illustrates the phase difference between the amount of phase change of the emission light L at each first liquid crystal portion 31 and the amount of phase change of the emission light L at each second liquid crystal portion 32, which are illustrated in FIG. 14. As illustrated in FIG. 15, the phase difference of the emission light L is a value obtained by subtracting the first phase P1 from the second phase P2 at the switching time point to. The magnitude of the phase difference of the emission light L decreases from the first phase difference PD1 at the switching time point to.

The phase difference of the emission light L decreases from 0 (zero) between the switching time point to and the fourth time point t4 and becomes a value obtained by subtracting the second phase P2 from the first phase P1 at the fourth time point t4 or later. The magnitude of the phase difference of the emission light L is the first phase difference PD1 at the fourth time point t4 or later.

Accordingly, the phase difference modulation element 2 causes the emission light L to exit therefrom in the fourth direction D4 before the switching time point to and causes the emission light L to exit therefrom in the fifth direction D5 at the fourth time point t4 or later. Between the switching time point to and the fourth time point t4, the direction of the emission light L changes from the fourth direction D4 to the fifth direction D5 over the fourth time T4.

In this manner, in the second switching operation in the comparative example, a switching time in which the direction of the emission light L switches from the fourth direction D4 to the fifth direction D5 is equivalent to the fourth time T4. However, there is a demand to shorten the switching time. Thus, the control circuit 3 controls voltage applied to the first and second electrodes 42 and 43 as described below.

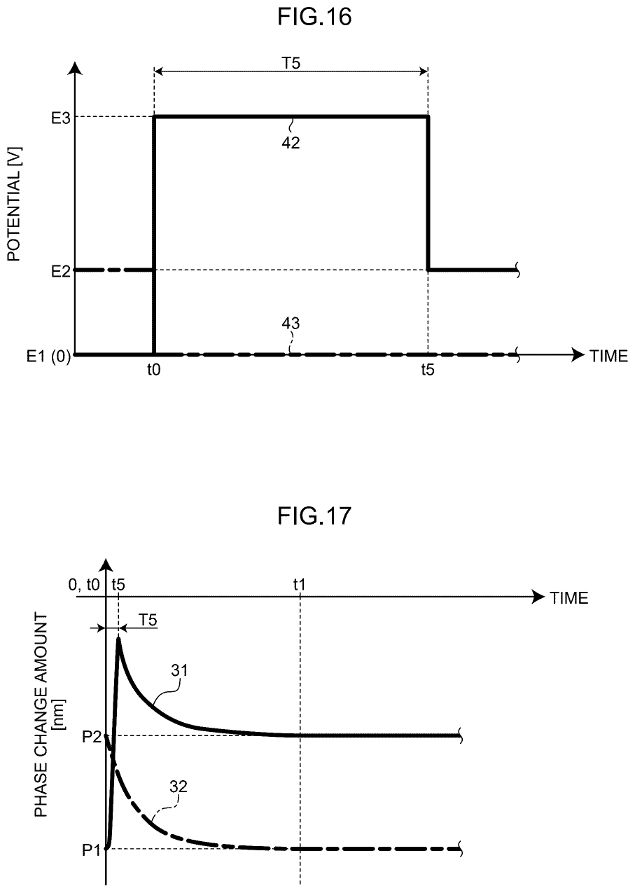

FIG. 16 is a time chart of the potentials of each first electrode 42 and each second electrode 43 in the second switching operation according to the embodiment of the present disclosure.

Before the switching time point to illustrated in FIG. 16, the potential of each first electrode 42 is the first potential E1 (reference potential; 0 (V)), the potential of each second electrode 43 is the second potential E2, and the phase difference modulation element 2 causes the emission light L to exit therefrom in the fourth direction D4 as described above.

In the second switching operation of the present embodiment, the control circuit 3 switches the potential of each second electrode 43 to the first potential E1 at the switching time point to, as in the second switching operation in the comparative example described above. The control circuit 3 switches the potential of each first electrode 42 from the first potential E1 to the third potential E3, which is higher than the second potential E2, at the switching time point to, and then to the second potential E2.

In the second switching operation of the present embodiment, the third potential E3 is set as follows. As illustrated in FIG. 4, the third potential E3 is higher than the second potential E2. The third phase P3 that is the amount of phase change of the emission light L, which corresponds to the third potential E3, is larger than the second phase P2. The second phase difference PD2 that is the magnitude of the difference between the second phase P2 and the third phase P3 is equal to or larger than the first phase difference PD1. The third potential E3 may be set so that the second phase difference PD2 is smaller than the first phase difference PD1.

As illustrated in FIG. 16, the control circuit 3 sets the potential of each first electrode 42 to the third potential E3 at the switching time point to. Then, the control circuit 3 switches the potential of each first electrode 42 from the third potential E3 to the first potential E1 at a fifth time point t5 after elapse of a fifth time T5 since the switching time point to. The fifth time T5 is set to a time that is shorter than the fourth time T4 and is set such that the degree of tilt of the liquid crystal molecules LM at each first liquid crystal portion 31 is larger than the degree of tilt of the liquid crystal molecules LM at each second liquid crystal portion 32 at the fifth time point t5. The fifth time T5 is set so that the magnitude of the difference between the degree of tilt of the liquid crystal molecules LM at each first liquid crystal portion 31 and the degree of tilt of the liquid crystal molecules LM at each second liquid crystal portion 32 at the fifth time point t5 is substantially equal to the magnitude of the difference between the degree of tilt of the liquid crystal molecules LM at each first liquid crystal portion 31 and the degree of tilt of the liquid crystal molecules LM at each second liquid crystal portion 32 at the switching time point to.

FIG. 17 is a time chart of the amounts of phase change of the emission light L at each first liquid crystal portion 31 and each second liquid crystal portion 32 in the second switching operation according to the embodiment of the present disclosure.

As in the first switching operation in the comparative example described above, when the potential of each second electrode 43 is switched from the second potential E2 to the first potential E1 at the switching time point to (refer to FIG. 16), the amount of phase change of the emission light L at each second liquid crystal portion 32 corresponding to the second electrode 43 decreases from the second phase P2 and becomes the first phase P1 at the first time point t1 as illustrated in FIG. 17.

When the potential of each first electrode 42 is switched from the first potential E1 to the third potential E3 at the switching time point to (refer to FIG. 16), the degree of tilt of the liquid crystal molecules LM at the first liquid crystal portion 31 corresponding to the first electrode 42 increases from the state of the initial alignment corresponding to the first potential E1. Accordingly, as illustrated in FIG. 17, the amount of phase change of the emission light L at the first liquid crystal portion 31 increases from the first phase P1 and becomes larger than the amount of phase change of the emission light L at the second liquid crystal portion 32. Since the fifth time T5 is set as described above, at the fifth time point t5, the amount of phase change of the emission light L at the first liquid crystal portion 31 is larger than the second phase P2, and the phase difference between the amount of phase change of the emission light L at the first liquid crystal portion 31 and the amount of phase change of the emission light L at the second liquid crystal portion 32 is substantially equal to the first phase difference PD1.

When the potential of each first electrode 42 is switched from the third potential E3 to the first potential E1 at the fifth time point t5 (refer to FIG. 16), the degree of tilt of the liquid crystal molecules LM at the corresponding first liquid crystal portion 31 decreases toward the degree of tilt corresponding to the second potential E2 due to the elasticity of the liquid crystal layer 30. Accordingly, as illustrated in FIG. 17, the amount of phase change of the emission light L at the first liquid crystal portion 31 decreases from the fifth time point t5 and becomes equal to the second phase P2 corresponding to the second potential E2.

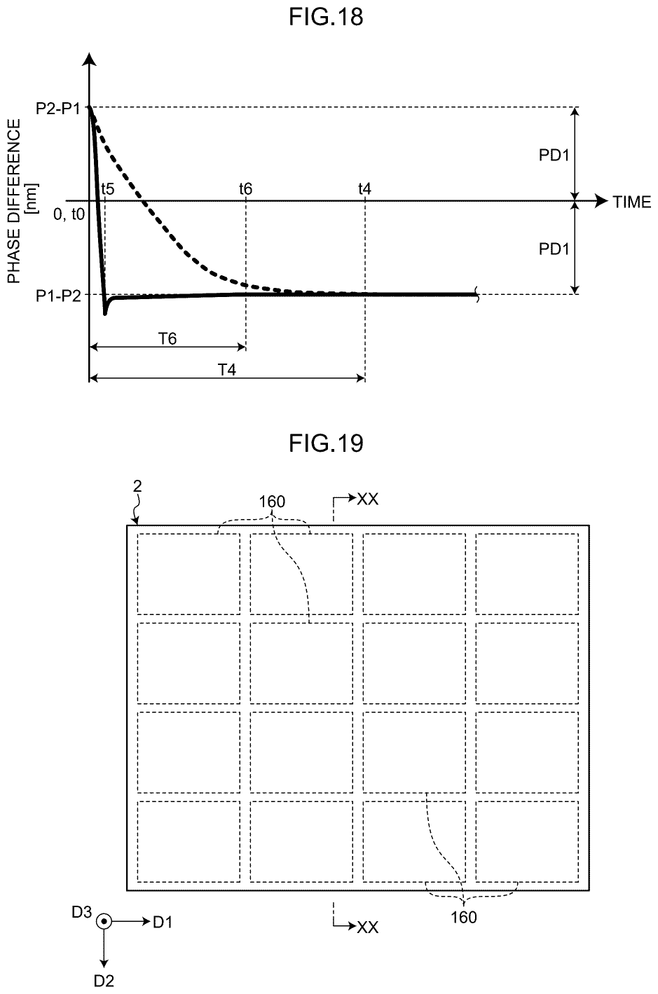

FIG. 18 is a time chart of the emission light L at each first liquid crystal portion 31 and the phase difference of the emission light L at each second liquid crystal portion 32 in the second switching operation according to the embodiment of the present disclosure. In FIG. 18, the phase difference of the emission light L related to the second switching operation according to the embodiment of the present disclosure is indicated with a solid line, and the phase difference of the emission light L related to the second switching operation in the comparative example illustrated in FIG. 15 is indicated with a dashed line.

FIG. 18 illustrates the phase difference between the amount of phase change of the emission light L at each first liquid crystal portion 31 and the amount of phase change of the emission light L at each second liquid crystal portion 32, which are illustrated in FIG. 17. As illustrated in FIG. 18, the phase difference of the emission light L is a value obtained by subtracting the first phase P1 from the second phase P2 at the switching time point to. The magnitude of the phase difference of the emission light L decreases from the first phase difference PD1 at the switching time point to.

The phase difference of the emission light L is smaller than 0 (zero) between the switching time point to and the fifth time point t5 and is a value obtained by subtracting the second phase P2 from the first phase P1 at a sixth time point t6 between the fifth time point t5 and the fourth time point t4. The magnitude of the phase difference of the emission light L is the first phase difference PD1 at the sixth time point t6 or later.

Accordingly, the phase difference modulation element 2 causes the emission light L to exit therefrom in the fourth direction D4 before the switching time point to and causes the emission light L to exit therefrom in the fifth direction D5 at the sixth time point t6 or later. In a sixth time T6 between the switching time point to and the sixth time point t6, the direction of the emission light L changes from the fourth direction D4 to the fifth direction D5 over the sixth time T6.

Between the sixth time point t6 and the fourth time point t4 in FIG. 18, the degree of tilt of the liquid crystal molecules LM at each of the first and second liquid crystal portions 31 and 32 changes while maintaining a state in which the magnitude of the phase difference of the emission light L is the first phase difference PD1. Accordingly, the emission light L is caused to exit in the fifth direction D5 at the sixth time point t6 or later.

In this manner, the switching time of the second switching operation of the present embodiment in which the phase difference modulation element 2 switches from a state of causing the emission light L to exit therefrom in the fourth direction D4 to a state of causing the emission light L to exit therefrom in the fifth direction D5, is equivalent to the sixth time T6 from the switching time point t0 to the sixth time point t6. The sixth time T6 is shorter the fourth time T4 equivalent to the switching time of the second switching operation in the comparative example. In this manner, the phase difference modulation device 1 can shorten a time required for the refractive state to change from a state in which the emission light L is refracted.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the emission light L does not necessarily need to be polarized light but may be, for example, natural light. In this case, a polarization plate having a transmission axis in the second direction D2 may be disposed in front of the phase difference modulation element 2.

The first and second electrodes 42 and 43 may be electrically coupled to the corresponding electric resistance film 41 in a state of being separated from the electric resistance film 41. Each element set 40 may include no electric resistance film 41.

The initial alignment of each liquid crystal molecule LM may be a state (vertical alignment) in which the long axis of the liquid crystal molecule LM is parallel to the third direction D3. In this case, the direction in which the emission light L is refracted is opposite to the refraction direction by the phase difference modulation element 2 of the above-described embodiment. For example, the emission light L is caused to exit in the fifth direction D5 when the potential of each first electrode 42 is the second potential E2 and the potential of each second electrode 43 and the potential of the third electrode 50 are the first potential E1.

Each element set 40 may be annular. In this case, the element set 40 includes an annular electric resistance film 41, an annular first electrode 42, and an annular second electrode 43. Also in this case, the first direction D1 corresponds to the radial direction, and the second direction D2 corresponds to the circumferential direction. The phase difference modulation element 2 including such annular element sets 40 functions like what is called a Fresnel lens. The phase difference modulation element 2 may include a plurality of annular element sets 40 having diameters different from one another, and the annular element sets 40 may be disposed such that their centers coincide with one another in a plan view.

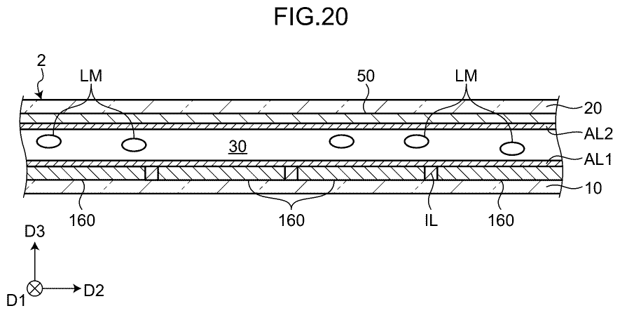

FIG. 19 is a plan view of a phase difference modulation element 2 included in a phase difference modulation device 1 according to a modification of the embodiment of the present disclosure. FIG. 20 is a sectional view of the phase difference modulation element 2 along line XX-XX illustrated in FIG. 19.

The phase difference modulation element 2 of the present modification includes a plurality of quadrilateral electrodes 160 in place of the element sets 40. Each quadrilateral electrode 160 has a quadrilateral shape in a plan view. The quadrilateral electrodes 160 are disposed on the first substrate 10 in a matrix of rows and columns in the first direction D1 and the second direction D2 in a plan view. The quadrilateral electrodes 160 overlap the third electrode 50 in a plan view. The number of quadrilateral electrodes 160 illustrated in FIG. 19 is 16 but is not limited to this number.

In the present modification, the control circuit 3 controls the potential of one of two quadrilateral electrodes 160 adjacent to each other in the second direction D2, in the same manner as the potential of each first electrode 42 in the above-described embodiment, and controls the potential of the other quadrilateral electrode 160 in the same manner as the potential of each second electrode 43 in the above-described embodiment. In this case, the control circuit 3 sets the same potential to two quadrilateral electrodes 160 adjacent to each other in the first direction D1. In this case as well, the phase difference modulation element 2 of the present modification can refract the emission light L in the same manner as the phase difference modulation element 2 of the above-described embodiment.

In the present modification, the control circuit 3 may control the potential of the quadrilateral electrode 160 on the most negative D2 side in the second direction D2 in the same manner as the first electrodes 42 of the above-described embodiment and may control the potential of the quadrilateral electrode 160 on the most positive D2 side in the second direction D2 in the same manner as the second electrode 43 of the above-described embodiment. In this case, the control circuit 3 sets the potentials of the quadrilateral electrodes 160 between the quadrilateral electrode 160 on the most negative D2 side and the quadrilateral electrode 160 on the most positive D2 side in the second direction D2, to potentials between the potential of the quadrilateral electrode 160 on the most negative D2 side and the potential of the quadrilateral electrode 160 on the most positive D2 side. Specifically, the control circuit 3 controls, among the quadrilateral electrodes 160 between the quadrilateral electrode 160 on the most negative D2 side and the quadrilateral electrode 160 on the most positive D2 side in the second direction D2, the potential of a quadrilateral electrode 160 on the negative D2 side of two quadrilateral electrodes 160 adjacent to each other in the second direction D2 to be a potential closer to the potential of the quadrilateral electrode 160 on the most negative D2 side than the potential of a quadrilateral electrode 160 on the positive D2 side. In this case, the control circuit 3 further controls the potentials of two quadrilateral electrodes 160 adjacent to each other in the first direction D1 to be the same. In this case as well, the phase difference modulation element 2 of the present modification can refract the emission light L in the same manner as the phase difference modulation element 2 of the above-described embodiment.

It should be understood that the present disclosure provides any other effects achieved by aspects described above in the above-described embodiments, such as effects that are clear from the description of the present specification or effects that could be thought of by the skilled person in the art as appropriate.

The control circuit 3 includes, for example, a central processing unit (CPU), a read only memory (ROM), a random access memory (RAM), an internal storage, an input interface, and an output interface. The CPU, the ROM, the RAM, and the internal storage are coupled to each other through an internal bus. The ROM stores a computer program such as BIOS. The internal storage is, for example, a hard disk drive (HDD) or a flash memory and stores operating system programs and application programs. The CPU implements various kinds of functions by executing computer programs stored in the ROM or the internal storage by using the RAM as a work area.

What is claimed is:

1. A phase difference modulation device comprising:
a first substrate provided with a first electrode and a second electrode that are disposed adjacent to each other in a plan view;
a second substrate provided with a third electrode overlapping the first and second electrodes in a plan view;
a liquid crystal layer disposed between the first and second substrates; and
a control circuit configured to apply voltage to the first, second, and third electrodes to impart a phase difference to an electromagnetic wave passing through the liquid crystal layer, wherein
when switching from a state in which the potential of the first electrode is a first potential and the potential of the second electrode is a second potential higher than the first potential to a state in which the potential of the second electrode is the first potential and the potential of the first electrode is a predetermined potential, the control circuit switches the potential of the first electrode from the first potential to a third potential higher than the predetermined potential and then to the predetermined potential.

2. The phase difference modulation device according to claim 1, wherein the magnitude of a phase difference of the electromagnetic wave, which corresponds to a potential difference between the second and third potentials, is equal to or larger than the magnitude of a phase difference of the electromagnetic wave, which corresponds to a potential difference between the first and second potentials.

3. The phase difference modulation device according to claim 1, further comprising an electric resistance film provided to the first substrate and electrically coupled to the first and second electrodes.

4. The phase difference modulation device according to claim 1, wherein the electromagnetic wave is visible light.
